(19) United States
(12) Patent Application Publication
(10) Pub. No.: US 2015/0142459 A1
(43) Pub. Date: May 21, 2015

(54) System, Method and Computer Program Product for Administering Consumer Care Initiatives

(71) Applicant: Optum, Inc., Minnetonka, MN (US)

(72) Inventors: Matt Nichols, Buffalo, MN (US); Michael Gualtieri, Medina, MN (US); Michael B. Wentzien, Chanhassen, MN (US)

(21) Appl. No.: 14/086,714

(22) Filed: Nov. 21, 2013

(51) Int. Cl. G06Q 10/06; G06Q 50/22

(52) U.S. Cl. CPC G06Q 10/06395; G06Q 50/22
USPC 705/2

(57) ABSTRACT

Consumer care initiatives are implemented by comparing recommended healthcare services with services assumed to have been received by the consumer which are identified through analyzing real-time consumer data. Based on the comparison, assumed gap closures in care are identified, and a consumer outreach suppression period is initiated for the one or more recommended healthcare services with the assumed gap closure during which an outreach initiative is inactive. Reactivation of the initiative may occur when the assumed gap closure is unconfirmed, or the initiative is removed when the healthcare services associated with the assumed gap closure is confirmed to have been received by the consumer. Evaluation of the real-time consumer data further allows for identification of a new disease or condition the consumer is assumed to be experiencing, resulting in the identification of assumed quality gap openings, which enables new care initiatives to be added to the consumer's outreach plan.

### TECHNICAL FIELD

This disclosure relates generally to systems, methods and computer program products for improving consumer care initiatives by identifying assumed gap closures and assumed gap openings in a consumer's healthcare.

### BACKGROUND OF THE DISCLOSURE

Payers are both incented and pressured to manage healthcare quality more aggressively and effectively. For example, some payers have not been able to effectively manage their Center for Medicare & Medicaid Services (“CMS”) Stars Rating programs due to the lack of timely, usable and actionable data. These payers have historically relied on retrospective annual data that is 1 to 2 years old and is not tied to actionable data that may otherwise provide payers with opportunities to improve their CMS Star ratings, to retain membership/revenue, and partner with CMS to improve the healthcare for their population. For example, prior quality programs have relied on retrospective Healthcare Effectiveness Data and Information Set (“HEDIS”) submission data that is typically submitted annually in the second quarter for adjudicated claims from the prior calendar year.

Even where the lag time in receiving actionable data is reduced from 1 to 2 years to 2 to 3 months, payer outreach to consumers to improve consumer healthcare often times results in dissatisfaction as consumers have already taken the action needed and payers have expended resources on outreach that is unnecessary.

For example, medical claims are commonly used to evaluate a patient or a patient population for the quality of a health plan. However, before medical claims are evaluated, the claims are adjudicated, which can take up to a few months. Even where claim adjudication occurs quickly, these claims are first loaded into a data warehouse where they are eventually extracted, typically on a monthly basis, for evaluation against quality measures (e.g., using a HEDIS engine). This process of evaluation can take two to three months for a single month's worth of data. For providers, this lag time can be cumbersome when analyzing the effectiveness of new consumer care initiatives. Particularly, when these initiatives are implemented, the provider generally requires about two to three months' worth of claims data in order to evaluate the new initiative. However, with the lag times involved in loading adjudicated claims into a data warehouse, monthly extractions and other processing that may be required to evaluate against quality measures, determining the effectiveness of the new care initiative can take at least six months. This can be problematic when providers are interested in redesigning or implementing the initiatives across member populations using various forms of outreach such as social media, print media, direct outreach, which requires education and training of those engaged in the member outreach initiatives. As a result, even with a 2 to 3 month lag time in receiving actionable data, this still may result in lengthy delays to improvements to the quality of healthcare.

### SUMMARY OF THE CLAIMS

The present disclosure discloses systems, methods and computer program products for providing improved consumer care initiatives and quality of healthcare.

According to one exemplary implementation, a computer-implemented method for improving consumer care initiatives is provided. The method involves using a computer processor to retrieve consumer data including consumer healthcare plan eligibility, historic claims data, recently adjudicated medical claim data, recently adjudicated medication prescription claim data and recent laboratory procedure data. The consumer data is analyzed against a set of predefined business rules to identify a group of healthcare services recommended for the consumer, e.g., gaps in care. The consumer data is analyzed to identify services performed, e.g., through evaluating diagnosis codes, procedure codes, medication identifiers, or lab procedures, identified in the consumer data to determine whether the services performed for the consumer satisfy these gaps in care. Any remaining gaps in care are identified as remaining recommended healthcare services for the consumer, e.g., gaps in care for the consumer. Real-time consumer data, which includes a diagnosis code, a procedure code, a medication identifier and/or a lab procedure that has not been adjudicated, is analyzed to identify services assumed to have been performed for the consumer, and these services are compared to the group of remaining recommended healthcare services to identify an assumed match therebetween, e.g., assumed gap closure(s). This assumed match corresponds to an assumption, as opposed to a confirmation, that the consumer received one or more remaining recommended healthcare services from the group based on the diagnosis code, procedure code, medication identifier and/or lab procedure identified in the real-time consumer data. A consumer outreach suppression period is initiated for the one or more remaining recommended healthcare services with the assumed match during which the one or more remaining recommended healthcare services are assumed to be received and an initiative to engage the consumer in receiving services associated with the assumed match is inactive in a consumer initiative queue. The outreach initiative is re-activated after the assumed match between the remaining recommended and received healthcare services remains unconfirmed based on adjudicated claim data. Otherwise, the initiative is removed from the consumer initiative queue based on confirming the one or more remaining healthcare services associated with the assumed match were received using the adjudicated claim data.

According to another exemplary implementation, a computer system is provided for improving consumer care initiatives. The system includes a computer processor configured to access a consumer activation plan stored in memory. The consumer activation plan includes a group of recommended healthcare services for a consumer, e.g., gaps in care for the consumer. Real-time consumer data is retrieved and analyzed against a set of predefined business rules to identify services performed, and the services are compared to the group of recommended healthcare services to identify an assumed match therebetween, e.g., assumed gap closure(s). A consumer outreach suppression period is initiated for the one or more recommended healthcare services with the assumed match during which the one or more recommended healthcare services are assumed to be received and an initiative to engage the consumer in receiving services associated with the assumed match is inactive. The outreach initiative is reactivated when the assumed match between the recommended and received healthcare services is unconfirmed. Otherwise, the initiative is removed after confirming the one or more healthcare services associated with the assumed match were received, thereby confirming the assumed match is an actual match.

In yet a further implementation, one or more non-transitory computer readable storage media encoded with instructions executable by a processor of a computing system may be provided. The instructions may be for: accessing a group of recommended healthcare services for a consumer; retrieving real-time consumer data and analyzing it against a set of predefined business rules to identify services performed and comparing these identified services to the group of recommended healthcare services to identify an assumed match therebetween. The instructions may further be for initiating a consumer outreach suppression period for the one or more recommended healthcare services with the assumed match during which the one or more recommended healthcare services are assumed to be received and an initiative to engage the consumer in receiving services associated with the assumed match is inactive. The outreach initiative is reactivated when the assumed match between the recommended and received healthcare services is unconfirmed, or the outreach initiative is removed after the assumed match period based on confirming the one or more healthcare services associated with the assumed match were received, thereby confirming the assumed match is an actual match.

### BRIEF DESCRIPTION OF THE DRAWINGS

FIG. 1 is a block diagram illustrating a system for improving consumer care initiatives.

FIG. 2 is a flow chart illustrating a method for identifying assumed gap closures and assumed gap openings in a consumer's healthcare. This method may be performed by the system of FIG. 1.

### DETAILED DESCRIPTION

### Definitions

“Consumers” may be health plan members including policy holders and family members of policy holders, and the terms consumer and member may be used interchangeably.

“Gaps in care” may be healthcare services recommended for a consumer that the consumer has not received. The recommended healthcare services are generally identified according to the consumer's age, gender, health condition(s), healthcare history and so on. Examples of gaps in care include but are not limited to gaps in: comprehensive diabetes care, osteoporosis management in women who had a fracture, use of imaging studies for low back pain, antidepressant medication management, follow-up care for children prescribed ADHD medication, follow-up after hospitalization for mental illness, diabetes screening for people with schizophrenia of bipolar disorder who are using antipsychotic medications, diabetes monitoring for people with diabetes and schizophrenia, cardiovascular monitoring for people with cardiovascular diseases and schizophrenia, adherence to antipsychotic medications for individuals with schizophrenia, annual monitoring for patients on persistent medications, use of high-risk medications in the elderly, adults' access to preventive/ambulatory health services, children and adolescents' access to primary care practitioners, annual dental visit, well-child visits in the first 15 months of life, well-child visits in the third, fourth, fifth and sixth years of life, adolescent well-care visits. Gaps in care may correspond to gaps in Healthcare Effectiveness Data and Information Set (“HEDIS”) measures. HEDIS measures span domains of care, and while the number of HEDIS measures may change periodically, presently about 80 HEDIS measures across eight domains of care (effectiveness of care, access/availability of care, satisfaction with the experience of care, health plan stability, use of services, cost of care, informed health care choices, health plan descriptive information) have been used to analyze the performance of health plans. Because HEDIS measures are a standardized set of performance measures, health plans can target compliance of these measures in order to improve the plan's rating and therefore performance among competing health plans.

“Healthcare quality patient assistance forms” (“HQPAFs”) may be a type of real-time consumer data. HQPAFs are generally forms listing a consumer's gaps in care, and a listing of services performed that satisfy an assumed gap in care closure.

“House call records” may be type of real-time consumer data. These records may include scheduled appointments to address gaps in care and based on the scheduled appointment, assumed gap closures may be identified.

“Pre-adjudicated claims” may be a type of real-time consumer data. Pre-adjudicated claims may be electronically submitted healthcare claim information that has not been adjudicated. The claim information may include the date of service (e.g., statement dates, discharge time, admission date); a description of the consumer (e.g., the patient) such as consumer demographic information; the consumer's condition for which treatment was provided, such as diagnosis codes such as ICD-9 and ICD-10-CM codes, principal diagnosis, admitting diagnosis, diagnosis related group (“DRG”) information, other diagnosis information; the services provided such as procedure codes including CPT and ICD-10-PCS codes, principal procedural information, other procedural information, occurrence span code information, occurrence code information; and the cost of the treatment such as payer estimated amount due and consumer estimated amount due. In addition, provider information such as the attending physician, operating physician, referring physician, and consumer physician may be included. Pre-adjudicated claims may be submitted by professionals (e.g., physicians), institutions (e.g., hospitals), dental practices and pharmacies. The submitted claims may be provided to a payer either directly or by way of intermediary billers and claims clearinghouses. Pre-adjudicated claims may be provided in an Accredited Standards Committee X12 837 claim feed format, which contain data elements for use within data exchange environments. Because a pre-adjudicated claim has not been adjudicated (e.g. manually or electronically), the information contained in it has not been validated. In addition, the claim has not yet been paid

A “payer” may be a third party that pays healthcare claims or administers insurance products, benefits or both and may include but is not limited to an insurance company, a health maintenance organization (“HMO”), a preferred provider organization (“PPO”), a government agency (e.g., Medicare, Medicaid, Civilian Health and Medical Program of the Uniformed Services (“CHAMPUS”)) or an administrator or organization that may be contracted with the aforementioned third parties.

“Providers” may be entities that provide health care products or services and may include physicians, hospitals, other medical facilities, dentists and/or pharmacies.

“Real-time consumer data” may include pre-adjudicated claims, data associated with pre-adjudicated claims, pharmacy claims, laboratory procedure data, house call records, data associated with house call records, healthcare quality patient assistance forms (“HQPAFs”) and/or data associated with HQPAFs. Generally, real-time consumer data is consumer healthcare information that has been received by a payer via a provider or a third party intermediary for analysis and processing in order to improve member care initiatives. The information may be a diagnosis code, a procedure code, a medication identifier and/or a lab procedure identifier that has not been processed or validated through adjudication. This information may be received relatively closer in time from the date it was generated compared to other forms of consumer data such as historic claims data that is generally two months to ten years old.

The above definitions are exemplary, should not be construed as limiting and may be more fully understood in the context of the present disclosure.

Overview

Implementations involve evaluating up-to-date consumer data against a consumer's healthcare history and outreach program information to identify assumed healthcare quality gap closures and openings in care. This may improve member care initiatives by allowing users to avoid solely relying on outdated information for evaluating the quality of a healthcare plan and/or the effectiveness of a payer's outreach program described above. More particularly, by evaluating real-time consumer data within a short timeframe from its date of creation, payers can identify assumed quality gap closures in care where the consumer has presumably engaged in healthcare activities within their outreach plan, which enables payers to refrain from further outreach related to the healthcare activity that is assumed to be complete. Identification of assumed quality gap closures may result in a reduction of 40 percentage points or more of unnecessary outreach calls. Evaluation of the real-time consumer data may further allow for the identification of a new disease or condition that the consumer is assumed to be experiencing, resulting in the identification of assumed quality gap openings, which enables new care initiatives to be added to the consumer's outreach plan. This may allow outreach initiatives associated with the consumer's assumed disease or condition to be deployed quickly.

Implementations of the present disclosure may be differentiated from prior approaches in that they: 1) utilize alternate real-time data sources to reduce the time it takes to identify the effectiveness of consumer initiatives; 2) identify from real-time consumer data assumed quality gap openings and closures for a limited time until they can either be confirmed or revert to “non-gaps” or open gaps in care; 3) suppress health plan members for particular measures from outreach plans during the period when they have an assumed quality gap closure or to add member to measures for which they have an assumed gap opening; 4) provide early trend reporting to demonstrate measure performance changes due to recent activity; and 5) provide leading indicators for campaign initiatives to more quickly determine if pilots should be adjusted, terminated, or expanded to full production.

### DETAILED DESCRIPTION OF THE FIGURES

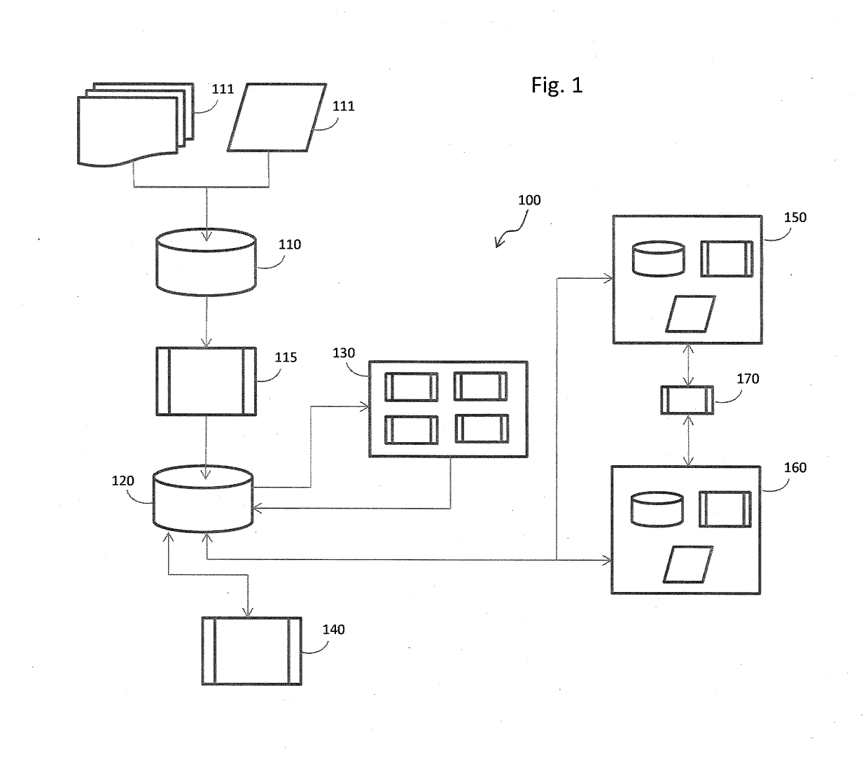

FIG. 1 is a block diagram illustrating a computer-implemented system 100 for improving member care initiatives in accordance with exemplary embodiments of the present disclosure. As shown in FIG. 1, the system 100 includes one or more databases 110 for storing incoming source data 111, which may include real-time consumer data such as pre-adjudicated claims data (e.g., pre-adjudicated medical, pharmacy and/or dental claims), house call records and HQPAFs received from providers, as well as campaign execution data that may be received from a quality measure feedback loop, described below. In addition or alternatively, the system 100 may be communicatively coupled to provider claims systems and receive source data therefrom.

The source data may be received at a server 115 (e.g., an ETL server) where it is analyzed and updated based on the consumer's health plan and contract information. The source data may additionally or alternatively be provided to a data warehouse 120 for storage along with post-adjudicated claims such as historical claims data. One or more servers 130 may use the post-adjudicated claims data to enrich the source data such as by identifying gaps in care (e.g., HEDIS measures), identifying Medicare Part D entitlements, segmenting the consumer using demographic information, identifying the consumer's primary care physician if not present in the claim. Enriching the source information using server 130 results in a usable data set that may be analyzed by one or more healthcare quality engines 140 to identify assumed gap closures and assumed gap openings, described below. Healthcare quality and risk engines 140 may be configured as rules engines that apply evidence-based medicine rules and may include HEDIS or HEDIS-like engines. Risk engines identify the risk of a consumer. For example, in Medicare, payers are reimbursed differently depending on the consumer's risk level, and consumer outreach initiatives to address gaps in care may result in a healthier consumer, thereby saving costs to the consumer and payer.

The system 100 may include a number of user portals such as a provider portal 150 for use by providers engaging in consumer care and outreach initiatives, and a reporting portal 160 that may be used to generate consumer activation reports usable by analysts involved in consumer care and outreach initiatives. Aspects of an exemplary reporting portal are described in a co-pending application having at least one common inventor having the Ser. No. 13/875,516, entitled “CMS Stars Rating Data Management,” and filed on May 2, 2013, the content of which is incorporated by reference in its entirety for any useful purpose. Each of the portals 150 and 160 may receive or be updated based on the identified assumed gap closures and openings as well as confirmed gap closures and openings, described below. The portals may be associated with a graphical user interface having a display screen. The portals may be general purpose computers having a processor, memory and a communicatively coupled display, keyboard and other input devices. General purpose computers may include devices such as personal computers, laptops, mobile devices and so on.

The system 100 may additionally include a campaign management platform and analytics engine 170 that analyze the consumer's assumed gap closures and openings to identify the most appropriate campaign to apply to the consumer. The analytics engine 170 may be communicatively coupled to the portals 150 and 160, which facilitates providing outreach programs with schedules and formatting targeted to a consumer or a consumer population.

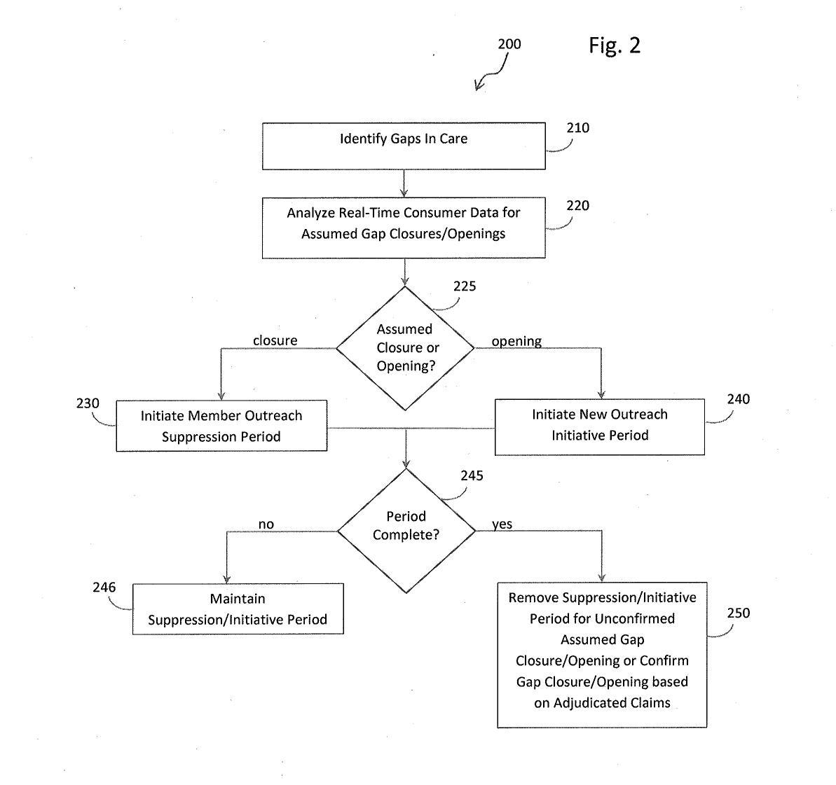

FIG. 2 illustrates a block diagram of a method 200 for improving member care initiatives in accordance with an exemplary embodiment of the present disclosure. The method 200 of FIG. 2 may be performed by the computer-implemented system of FIG. 1. As shown in FIG. 2, the computer-implemented method 200 involves identifying gaps in care in step 210. The method 200 continues by analyzing real-time consumer data to identify assumed gap closures, assumed gap openings or both in step 220. For assumed gap closures identified in step 225, a member outreach suppression period is initiated in step 230, while for assumed gap openings identified in step 225, a new initiative is activated in step 240. After a predefined period of time identified in step 245/246, the suppression period or the new initiative is either removed or confirmed based on confirming the assumed gap closures/openings are actual gap closures/openings in step 250.

At step 210, gaps in care may be identified by analyzing consumer data to identify healthcare services recommended for the consumer that the consumer has not yet received. For example, consumer data is analyzed against a set of predefined business rules to identify a group of healthcare services generally recommended for the consumer, e.g., a general set of gaps in care. The group of services recommended is based on evaluating the consumer healthcare plan eligibility, historic claims data, recently adjudicated medical claim data, recently adjudicated medication prescription claim data, and/or recent laboratory procedure data to identify services recommended for the consumer. Determining consumer healthcare plan eligibility may involve identifying the services for which the consumer qualifies under their healthcare plan. Historic claims data may be claims data from the past two to ten years. Consumer data that is recently adjudicated, such as recently adjudicated medical, prescription and laboratory procedure data, may be a set of data that is received from a data storage device on a periodic basis, such as weekly, bi-weekly or monthly. This information may be monthly aggregations of claims data extracted from a data warehouse. Although recently adjudicated consumer data may be retrieved on a relatively frequent basis, as mentioned herein, this data is typically at least 60 days old. In addition, consumer demographic information may be used to identify recommended services. Pre-defined business rules used to evaluate the consumer data for gaps in care may be evidence-based medicine rules. In some cases the evidence-based medicine rules are implemented in healthcare quality analytics engines such as HEDIS or HEDIS-like engines. In some cases, identification of gaps in recommended healthcare services for the consumer may further involve analyzing the consumer data to identify services actually performed for the consumer and comparing these against the group of recommended healthcare services to identify correspondence therebetween. For example, correspondence may be based on matching a diagnosis or a procedure code, a medication identifier, or a lab procedure identified in the claim data with the medical codes associated with the group of recommended healthcare services. Where the consumer has received a recommended healthcare service, a gap in care is not present. Where correspondence is not identified, the consumer is considered to be experiencing a gap in care for that recommended healthcare service. A group of healthcare services recommended for the particular consumer, e.g., gaps in care for the consumer, is generated based on those recommended services identified as not having been performed for the consumer. Other methods for generating gaps in care may be performed in addition or as an alternative to the description above, and those skilled in the art will understand that the above steps involved in generating gaps in care are exemplary.

The method 200 continues by analyzing real-time consumer data to identify assumed gap closures, assumed gap openings or both in step 220. For example, the received real-time consumer data may be analyzed against a set of predefined business rules to determine that the services performed correspond to a gap in the consumer's care resulting in the identification of an assumed gap closure. More particularly, the real-time member data may contain or be associated with one or more diagnosis codes, procedure codes, medication identifiers and/or lab procedures that relate to healthcare services the consumer is assumed to have received, and some of these services may be for healthcare services that the consumer had not yet received but were recommended for the consumer. Accordingly, the services identified may be compared to the gaps in care for the consumer, i.e., to the group of recommended healthcare services for the consumer, and assumed gap closures may be generated by identifying correspondence between the received and recommended services. Assumed gap closures are in contrast to confirmed gap closures for adjudicated claims, described below, at least because the services performed are not yet confirmed through adjudication.

In addition or alternatively, assumed gap openings may be identified in step 220. In this case, services the consumer is assumed to have received are identified and evaluated to determine if the member qualifies for additional quality measures. For example, a diagnosis code and/or procedure code identified in the real-time member data can be analyzed using pre-defined business rules to identify a new assumed diagnosis, disease and/or disease-precursor, which may qualify the consumer for additional services. Assumed quality gap openings may be generated based on the identification of the additional healthcare services that are recommended for the consumer that the consumer has not yet received.

Accordingly, quality compliance or non-compliance for a consumer or a population under a plan may be identified in real-time by analyzing the real-time member data against criteria defined by healthcare quality measures.

In some implementations, prior to identification of the assumed gap closures/openings, the real-time consumer data may be processed to identify medical codes (e.g., diagnosis and procedure codes), medication identifiers, lab procedures and so on. Ancillary information such as estimated costs for services may be filtered from the data. Where the real-time consumer data includes pre-adjudicated claims, the pre-adjudicated claims may be provided in a parsable format such as an Accredited Standards Committee X12 837 claim feed format. Parsing the pre-adjudicated claims involves segmenting claims data into usable data by assigning values to fields, which allows the information to be processed in quality engines. Pre-adjudicated claims therefore differ from adjudicated claims, which are typically received in a usable, tabular form and include data that has already been parsed into tables.

Processing the real-time consumer data may additionally or alternatively involve enriching the data using healthcare plan eligibility, health history information and segment information (e.g., demographics). Healthcare plan eligibility information may be used to identify the services for which the consumer qualifies. Health history information may include two to ten years of historic claims data, and these previously adjudicated claims can be used to identify the consumer's primary care physician, health history and segment information. In addition, the consumer's electronic medical records may be used. This information may be used to supplement the real-time consumer data that may otherwise be incomplete for purposes of analysis against evidence-based medicine rules or in quality analytics engines. Furthermore, the real-time consumer data may be coded for use in quality analytics engines.

The real-time consumer data may be evaluated on a frequent, periodic basis such as a daily basis. For example, a SQL extraction query of 837 claims feeds may utilize an @ExtractFromDate variable to set the start boundary for a date filter, which may be set to the (@ExtractToDate+1) from the previous run, and an @ExtractToDate to set the end boundary for the date filter, which may be set to GETDATE( )−1 (one day prior to current day). TIMESTAMP fields that include both date and time components may be used to identify and confirm incremental updates are not being repeated, e.g., using INSRT_TS and LST_UPDT_TS fields. To extract rows since the previous extraction of the 837 claims feeds, the following logic may be used: WHERE (INSRT_TS BETWEEN @ExtractFromDate AND @ExtractToDate) OR (LST_UP_DT_DT BETWEEN @ExtractFromDate AND @ExtractToDate). A log entry may be made at start and end of package execution, for example, by placing in the OnPackageCompletion event handler of each package.

Returning to method 200, for assumed gap closures identified in step 225, a member outreach suppression period may be initiated in step 230. An outreach suppression period may correspond to a period during which outreach initiatives to engage the member in receiving services associated with the assumed gap closure is inactive. The inactive status of the outreach initiative may be provided in a member initiative queue with a listing of gaps in care, and those with assumed gap closures may be marked differently than open gaps in care.

For assumed gap openings identified in step 225, a new initiative and an associated new initiative outreach period may be activated in step 240, and the new initiative may be added to the member initiative queue. As further evaluations of the consumer data are conducted, an engagement suppression period for the new initiative may be activated based on an assumed match between the services identified from the real-time consumer data and the services associated with the new initiative.

A determination is made as to whether a period of time has elapsed for the outreach suppression/initiative in step 245. If not, the method continues my maintaining the suppression/initiative period in step 246. Otherwise, the outreach suppression period or the new initiative is either removed or the gap closure/opening is confirmed in step 250. Confirmation may generally be obtained through comparison of adjudicated claims data with the real-time consumer data used to identify the assumed gap closure/opening. Where correspondence between the two is identified, the assumed gap closure/opening may be confirmed as an actual gap closure/opening. In addition or alternatively, supplemental data submissions may be used to confirm gap closures/openings. In one example, a supplemental data submission may be a follow-up submission to a house call in which the provider reports the services provided to the consumer such as those services scheduled to address the consumer's gaps in care.

For assumed gap closures, when confirmation of the gap closure is not received, the assumed gap closure indication may be removed, and the outreach initiative and/or member initiative queues may be updated to include the consumer for the quality gap measure that is not closed. For assumed gap openings, when confirmation of the new condition or diagnosis is not received, the new initiative may be removed from the outreach initiative and/or member initiative queues. Alternatively, confirmation of the gap closure/opening may be received based on confirming that an assumed gap closure/opening is an actual gap closure/opening using adjudicated claims containing information that confirming the healthcare services associated with the assumed gap closure/opening were actually received. The outreach suppression period and/or the new initiative outreach period may last for a pre-defined period of time, such as 30 days, 60 days, 90 days, or any value therebetween; 1 to 3 months, or any value therebetween; may last for the time it takes to adjudicate the claim associated with the assumed gap closure and compare it to the pre-adjudicated claim or consumer data associated with the assumed gap closure/opening; or may last until the earlier of the pre-defined period of time or the time it takes to adjudicate and conduct the pre-/post-adjudicated claim.

The following examples are for purposes of illustration and are not to be construed as limiting.

Assumed Gap Closure

According to an exemplary embodiment of the present disclosure, claim data related to a consumer receiving a mammogram may result in the generation of an assumed gap closure, which may facilitate the efficient administration of consumer care initiatives. In this case of a mammogram, a pre-adjudicated claim may be parsed and the procedure field includes a mammogram procedure code. For a female aged 25-64, a mammogram is recommended annually. The pre-adjudicated claim may be enriched to include the consumer's age, and in this example, the consumer is a female who is 35. Next, based on reviewing historical consumer healthcare data, the consumer has not had a mammogram in over twelve months. Processing the procedure code, age, gender and health history information in a quality engine results identifying an assumed gap closure and an outreach suppression period for the consumer linked to the pre-adjudicated claim. During this suppression period, outreach to the member is stopped. After the claim is adjudicated, and the procedure is confirmed to have been a mammogram, then the assumed gap closure is confirmed and no further outreach is provided. However, where the claim is adjudicated and the procedure is identified as a glaucoma test and not a mammogram, then the assumed gap closure is unconfirmed and the outreach for the consumer to receive a mammogram may be re-initiated.

Assumed Gap Opening

According to another exemplary embodiment of the present disclosure, claim data related to a consumer diagnosed with diabetes may result in the generation of an assumed gap opening, which may facilitate the timely activation of consumer care initiatives. In this case of diabetes, for consumers with a new diabetic diagnosis, a cholesterol screening is recommended. Here, the consumers pre-adjudicated claims are parsed and the diagnosis field includes a diagnosis code for diabetes and potentially procedure codes for services provided related to the treatment of diabetes. The diagnosis and procedure codes, along with the consumers' demographic information and health history, may be evaluated against quality measures, and healthcare recommendations such as cholesterol screening may be generated resulting in an assumed gap opening. Where member outreach initiatives are ongoing for diabetics needing cholesterol screening, the consumers with this new diagnosis may be added to the outreach initiative. As described above, adjudicated claim data may be used to confirm the gap opening or to determine the consumer does not have diabetes and thus does not qualify for the recommended care.

Consumer Activation Reporting

According to yet another exemplary embodiment, consumer activation reports may be generated based on assumed quality gap closures and openings to more effectively engage in consumer outreach initiatives. For example, activation reports that contain information about the quality of a health plan and the number of gaps in care that need to be closed to improve the quality of the plan. The report can include a list of members with at least one identified gap in care. According to the present disclosure, the report may be updated on a frequent basis (e.g., daily, once every other day, daily on week days, weekly and so on) to identify members with an assumed gap closure based on analyzing real-time consumer data according to the methods described above, which enables the consumer with the assumed gap closure(s) to be removed from one or more outreach initiatives. In addition, the report may be prioritized to list consumers with the highest priority gaps in care, and sub-sorted according the consumers with the highest number of gaps in care. Based on the real-time updates in which consumers with assumed gap closures are removed from the list, the report may be re-prioritized to enable outreach to consumers with the highest need. Furthermore, a consumer may be added to an activation report based on the analysis of the real-time consumer data to enable early consumer outreach.

Although the present disclosure describes generation of assumed gap closures/openings in the context of a consumer, the methods of the present disclosure are applicable to generating assumed gap closures/openings for a population, such as a group of health care plan members. By evaluating a population, activation queues for the given population may be updated on a real-time basis, resulting in the efficient administration of care initiatives.

Furthermore, integration of the assumed gap closures/openings with reporting may provide for early quality measure trending and leading indicators for the success or failure of quality program initiatives. This may enable faster decisions to be made on adjustments, expansions, or cessation of initiatives. The methods of the present disclosure may be utilized along with platforms for management of Stars ratings, HEDIS measure reporting, HQPAF forms, and other quality reporting and program management products and services to provide early indicators for the success or failure and temporary suppressors or additions for outreach campaigns while members have assumed gap closures/openings.

In further implementations, assumed gaps in care may be evaluated to identify the most appropriate outreach campaign to apply to the consumer. For example an outreach campaign schedule and media (e.g., outreach via phone, electronic communication or both) may be tailored to the consumer based on the consumer's demographics and assumed gaps in care.

The embodiments described may be provided as a computer program product, or software, that may include a computer-readable storage medium or a non-transitory machine-readable medium holding stored instructions, and may be used to program a computer to perform one or more processes of the present disclosure. The non-transitory machine-readable medium may take the form of, but is not limited to, a magnetic storage medium; optical storage medium; magneto-optical storage medium; read only memory (“ROM”); random access memory (“RAM”); erasable programmable memory (e.g., “EPROM” and “EEPROM”); flash memory; and so on.

While the methods disclosed herein have been described and shown with reference to particular operations performed in a particular order, it will be understood that these operations may be combined, sub-divided, or re-ordered to form equivalent methods without departing from the teachings of the present disclosure. Accordingly, unless specifically indicated herein, the order and grouping of the operations is not a limitation of the present invention.

It should be appreciated that reference throughout this specification to “one embodiment” or “an embodiment” or “one example” or “an example” means that a particular feature, structure or characteristic described in connection with the embodiment may be included in at least one embodiment of the present invention. Therefore, it should be appreciated that two or more references to “an embodiment” or “one embodiment” or “an alternative embodiment” or “one example” and “an example” in various portions of this specification are not necessarily all referring to the same embodiment. Furthermore, the particular features, structures or characteristics may be combined as desired in one or more exemplary embodiments.

Similarly, it should be appreciated that in the foregoing description of example embodiments, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed inventions require more features than are expressly recited in each claim. Rather, as the following claims reflect, inventive aspects lie in less than all features of a single foregoing disclosed embodiment, and each embodiment described herein may contain more than one inventive feature.

While the invention has been particularly shown and described with reference to embodiments thereof, it will be understood by those skilled in the art that various other changes in the form and details may be made without departing from the spirit and scope of the invention.

What is claimed is:

1. A computer-implemented method for improving consumer care initiatives, the method comprising:
(a) retrieving consumer data comprising at least consumer healthcare plan eligibility, historic claims data, recently adjudicated medical claim data, recently adjudicated medication prescription claim data and recent laboratory procedure data using a computer processor;
(b) analyzing the consumer data against a set of predefined business rules to identify a group of healthcare services recommended for the consumer using the computer processor;
(c) analyzing the consumer data to identify services performed and comparing to the group of recommended healthcare services to identify a match therebetween using the computer processor, said match based on one or more of a diagnosis code, a procedure code, a medication identifier or a lab procedure identified in the consumer data;
(d) identifying a group of remaining recommended healthcare services recommended for the consumer using the computer processor;
(e) retrieving real-time consumer data comprising one or more of a diagnosis code, a procedure code, a medication identifier or a lab procedure, wherein the real-time consumer data has not been adjudicated;
(f) analyzing the real-time consumer data against a set of predefined business rules to identify services performed based on the one or more of a diagnosis code, a procedure code, a medication identifier or a lab procedure in the real-time consumer data;
(g) comparing the identified services to the group of remaining recommended healthcare services to identify an assumed match therebetween using the computer processor, said assumed match corresponding to an assumption that the consumer received one or more remaining recommended healthcare services from the group;
(h) initiating a consumer outreach suppression period for the one or more remaining recommended healthcare services with the assumed match during which the one or more remaining recommended healthcare services are assumed to be received and an initiative to engage the consumer in receiving services associated with the assumed match is inactive in a consumer initiative queue using the computer processor; and
(i) re-activating the outreach initiative after a period of time when the assumed match between the recommended and received healthcare services is unconfirmed from adjudicated claim data, or removing the initiative after the period of time when the assumed match is confirmed from adjudicated claim data using the computer processor.

2. The method of claim 1, wherein the predefined business rules are derived from evidence-based medicine guidelines.

3. The method of claim 2, wherein the predefined business rules are further derived from healthcare performance measures.

4. The method of claim 2, wherein the healthcare performance measures are Healthcare Effectiveness Data and Information Set (“HEDIS”) measures.

5. The method of claim 1, wherein the historic claims data is about two to ten years of past claims data for the consumer.

6. The method of claim 1, wherein the recent medical claims data comprises monthly aggregations of claims data.

7. The method of claim 1, wherein the real-time consumer data comprises one or more of pre-adjudicated medical claims data, prescription claims data or laboratory procedure data.

8. The method of claim 1, wherein the step of retrieving the real-time consumer data further comprises retrieving consumer data comprising at least consumer healthcare plan eligibility, two to ten years of historic claims data and electronic medical records.

9. The method of claim 1, wherein the real-time consumer data is derived from claims that have not been paid.

10. The method of claim 9, wherein data from the claims that have not been paid is parsed from an Accredited Standards Committee X12 837 claim feed format.

11. The method of claim 1, further comprising:
analyzing the real-time consumer data against the set of predefined business rules to identify a group of healthcare services recommended for the consumer using the computer processor; and
activating a further initiative in the consumer initiative queue to engage the consumer in receiving the group of healthcare services recommended for the consumer.

12. The method of claim 11, further comprising initiating an engagement suppression period during which the further initiative is inactive in the consumer initiative queue.

13. A computer system, the system comprising:
a computer processor configured to:
(a) access a consumer activation plan stored in memory, the consumer activation plan comprising a group of recommended healthcare services recommended for a consumer based on comparing a health history and previously adjudicated claims of the consumer with evidence-based medicine guidelines;
(b) retrieve real-time consumer data comprising one or more of a diagnosis code, a procedure code, a medication identifier or a lab procedure, wherein the real-time consumer data has not been adjudicated;
(c) analyze the real-time consumer data against a set of predefined business rules to identify services performed based on the one or more of a diagnosis code, a procedure code, a medication identifier or a lab procedure identified in the real-time consumer data;
(d) compare the identified services to the group of recommended healthcare services to identify an assumed match therebetween, said assumed match corresponding to an assumption that the consumer received one or more recommended healthcare services from the group;
(e) initiate a consumer outreach suppression period for the one or more recommended healthcare services with the assumed match during which the one or more recommended healthcare services are assumed to be received and an initiative to engage the consumer in receiving services associated with the assumed match is inactive; and
(f) re-activate the outreach initiative after a period of time when the assumed match between the recommended and received healthcare services is unconfirmed from adjudicated claim data, or remove the initiative after the period of time when the assumed match is confirmed from adjudicated claim data.

14. The system of claim 13, wherein the computer processor is further configured to:
analyze the real-time consumer data against evidence-based medicine guidelines to identify a group of healthcare services recommended for the consumer using the computer processor; and
activate a further outreach initiative to engage the consumer in receiving the group of healthcare services recommended for the consumer.

15. The method of claim 14, wherein the computer processor is further configured to:
initiate an engagement suppression period during which the further outreach initiative is inactive based on an assumed match.

16. The method of claim 15, wherein the computer processor is further configured to:
re-activate the further outreach initiative after the engagement suppression period in which the assumed match between the recommended and received healthcare services is unconfirmed based on adjudicated claim data, or removing the further outreach initiative after the engagement suppression period based on confirming the one or more healthcare services associated with the assumed match were received based on the adjudicated claim data thereby confirming the assumed match is an actual match.

17. The method of claim 13, wherein analyzing further comprises determining at least one diagnosis code or procedure code in the real-time consumer data and analyzing the at least one code against the evidence-based medicine guidelines to identify the group of healthcare services recommended for the consumer.

18. One or more non-transitory computer readable storage media encoded with instructions executable by a processor of a computing system, the instructions comprising instructions for:
(a) accessing a group of recommended healthcare services for a consumer;
(b) analyzing the real-time consumer data to identify services performed based on one or more of a diagnosis code, a procedure code, a medication identifier or a lab procedure associated with the real-time consumer data;
(c) comparing the identified services to the group of recommended healthcare services to identify an assumed match therebetween, said assumed match corresponding to an assumption that the consumer received one or more recommended healthcare services from the group;
(d) initiating a consumer outreach suppression period for the one or more recommended healthcare services with the assumed match during which the one or more recommended healthcare services are assumed to be received and an initiative to engage the consumer in receiving services associated with the assumed match is inactive; and
(e) re-activating the outreach initiative when the assumed match between the recommended and received healthcare services is unconfirmed from adjudicated claim data, or removing the initiative when the assumed match is confirmed from adjudicated claim data.

19. The non-transitory computer readable storage media of claim 18, wherein the real-time consumer data comprises one or more of pre-adjudicated medical claims data, prescription claims data or laboratory procedure data.

20. The non-transitory computer readable storage media of claim 18, wherein the real-time consumer data is parsed from claims feeds.
